(19) United States
(12) Patent Application Publication
(10) Pub. No.: US 2004/0165224 A1
(43) Pub. Date: Aug. 26, 2004

(54) Compact optical scanner

(76) Inventor: Ross R. Allen, Belmont, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/370,862

(22) Filed: Feb. 21, 2003

(51) Int. Cl. H04N 1/04; H04N 1/407

(52) U.S. Cl. 358/474; 358/496; 358/498

(57) ABSTRACT

A slot scanner, for generating a scanned electronic image of a document, comprises a housing with a slot configured for manually feeding the document through the slot, so that feed mechanisms are not necessary. The slot extends completely through the housing and has first and second openings. The slot defines an interior surface of the housing. The following components are positioned on the interior surface: an image sensor extending over substantially the entire length of the slot, a navigational sensor, and an illuminator positioned proximate to the image and navigational sensors. The scanner includes an image processor enabled to track movement of the document and to generate an electronic image of the document based on data from the image and navigational sensors. A method is described for removing image distortion artifacts from the image data, arising from the non-uniform way in which the document may be moved through the slot. This method utilizes data from the navigational sensors.

### TECHNICAL FIELD

The invention relates generally to the field of optical scanning and more particularly to document scanning methods and structural arrangements for use in optical scanning applications.

### BACKGROUND ART

A typical optical scanner, used to produce an electronic image of a document, comprises an illuminator, an image sensor and an optical system which focuses a small area of an illuminated document, usually referred to as a “scan line,” onto the image sensor. The entire document is then scanned by moving the illuminated “scan line” across the document—either by moving the document with respect to the illuminator, image sensor and optical system or by moving the illuminator, image sensor and optical system relative to the document. Generally, the movement of the document or the combination of the illuminator, image sensor and optical system is controlled by a mechanical assembly that operates to ensure that the “scan line” moves in a uniform way and at a uniform rate over the entire document. However, such a mechanical assembly typically adds bulk, weight and cost to a scanner, impacts reliability, and results in a slow scan rate for documents.

There are freehand document scanners that are manually moved over documents in order to capture an electronic image. For the electronic image of the document to be complete, the user performing the scan must be careful to scan the entire document, generally by acquiring overlapping swaths of document image data which are then “stitched together” by a processor.

U.S. Pat. No. 5,578,813 to Allen et al., which is assigned to the assignee of the present invention, describes a freehand document scanner which compensates for non-uniform movement of the image sensor as it is manually moved over the document. The scan device includes an image sensor and at least one navigational sensor. For example, the image sensor may be a one-dimensional array of sensor elements and there may be a separate two-dimensional navigational sensor array at each end of the image sensor. Each navigational sensor acquires positional information while the image sensor is capturing image data that is then “stitched” together on the basis of the positional information. The navigational sensor may track movement of the image sensor over the document by monitoring variations of inherent structure-related properties of the document. Possible inherent structure-related properties include features such as paper fibers of a paper document and specular patterns of a glossy document. Aspects of freehand document scanners are also described in U.S. Pat. No. 5,644,139 to Allen et al., U.S. Pat. No. 5,825,044 to Allen et al., U.S. Pat. No. 6,005,681 to Pollard, U.S. Pat. No. 6,195,475 to Beausoleil, Jr. et al., U.S. Pat. No. 6,249,360 to Pollard et al., and U.S. Pat. No. 6,259,826 to Pollard et al., all of which are assigned to the assignee of the present invention. While known optical scanners operate well for their intended purposes, further advancements are available.

### SUMMARY OF THE INVENTION

The present invention provides an apparatus for scanning documents. The apparatus includes a housing with a slot through which documents are manually passed, so that mechanisms are not required to guide and control the movement of the document through the slot. Sensors within the slot collect image data and navigation data, from which an electronic image of the document is generated. More specifically, the apparatus comprises a housing with a slot configured to accommodate the manual feeding of a document through the slot. The slot extends completely through the housing and has first and second openings. The slot defines an interior surface of the housing. An image sensor and a navigational sensor are positioned on the interior surface. The following components may be positioned on the interior surface: an image sensor extending over substantially the entire width of the slot, a navigational sensor, and an illuminator positioned proximate to the image and navigational sensors. The scanner includes an image processor enabled to track movement of the document and to generate an electronic image of the document based on data from the image and navigational sensors.

The invention provides a method for scanning documents. A document is manually fed through a slot (document passageway) in a housing. As the document moves through the slot, a sequence of image data is captured and navigation information is generated. The navigation information is representative of movement of the document through the slot, including variations in skew and speed of the document. An electronic image is formed from the image data, including removing image distortion artifacts arising from the way in which the document moves through the slot. The removal of image distortion artifacts is achieved using the navigation information.

### BRIEF DESCRIPTION OF THE DRAWINGS

FIG. 1 is a perspective view of a slot scanner in accordance with the invention.

FIG. 2 is a perspective view of a wall-mounted slot scanner, which is one embodiment of a scanner in accordance with the invention, in a condition in which a document is dropping through the scanner.

FIG. 3 is a perspective view of the scanner of FIG. 2, in a condition in which a document is being manually pushed through the scanner.

FIG. 4 is a perspective view of the scanner of FIG. 2, in a condition in which a document is being manually pulled through the scanner.

FIG. 5 is a perspective view of a wall-mounted slot scanner in accordance with the invention.

FIG. 6 is a cross-section through a first embodiment of the scanner of FIG. 5, in the vertical plane along lines 5-5.

FIG. 7 is a plan view of one embodiment of a sensor substrate which may be employed with a scanner that is formed in accordance with the invention.

FIG. 8 is a cross-section through a second embodiment of the scanner of FIG. 5, in the vertical plane along lines 5-5.

FIG. 9 is a perspective view of a wall-mounted slot scanner with a document guide, in accordance with the invention.

FIG. 10 is a cross-section through the scanner of FIG. 9, in the vertical plane along lines 9-9.

FIG. 11 is a conceptual representation of the image capture operation of a slot scanner, in accordance with the invention.

FIG. 12 is a block diagram of components that are relevant to scanning operations of scanners in accordance with the invention.

FIG. 13 is a diagrammatic representation of the process of generating navigation information, in accordance with the invention.

FIG. 14 is a perspective view of a slot scanner integrated into a computer keyboard, in accordance with the invention.

### DETAILED DESCRIPTION

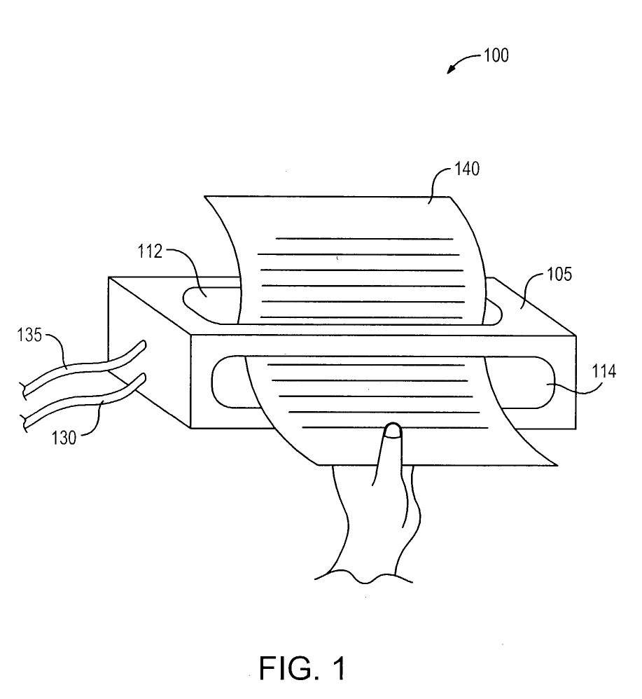

With reference to FIG. 1, slot scanner 100, which is an embodiment of the invention suitable for use on desks, tables and other horizontal surfaces, is shown with a document 140 being manually passed through a slot (document passageway) in a housing 105. The slot has first and second openings 112 and 114. An electronic image of the document is generated by using optical scanning hardware located along the slot. Cable 130 provides power to the scanner, and cable 135 is a serial, USB, SCSI or parallel data connection, typically connected to a computer. The slot is shown with openings on the top and front surfaces of the scanner, but alternative configurations may include openings on the back and front surfaces.

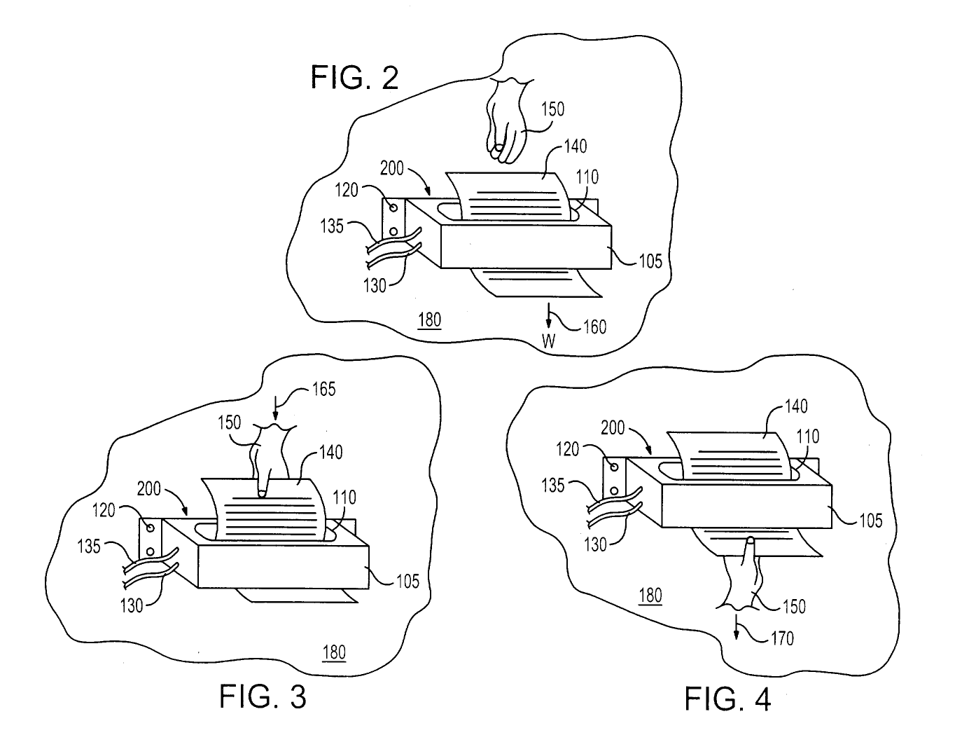

With reference to FIGS. 2, 3, 4 and 5, a wall-mounted slot scanner 200, which is an embodiment of the invention suitable for mounting on a variety of vertical surfaces (such as the side of a piece of office furniture or a wall), is shown with a slot 110 through the housing 105. The slot extends from the top surface to the bottom surface of the housing. An electronic image of the document is generated by using optical scanning hardware located along the slot 110. The slot scanner 200 is attached to a vertical surface 180 by attachment hardware 120 (for example: bolts, screws, etc.). Cable 130 provides power to the scanner, and cable 135 is a serial, USB, SCSI or parallel data connection, typically to a computer. Alternative configurations for the wall-mounted slot scanner may include a slot with openings on the top and front surfaces of the housing.

In FIG. 2, the document 140 is shown being manually dropped (by hand 150) through the slot 110. The weight of the document alone is sufficient to cause the document to pass through the slot. The weight, W, is a force acting on the document in the direction 160. In FIG. 3, the document 140 is shown being pushed by hand 150 (the force on the document acts in the direction 165) through the slot 110. In FIG. 4, the document 140 is shown being pulled by hand 150 (the force on the document acts in the direction 170) through the slot 110. During regular use, it is expected that a combination of some or all of the above techniques will be used to manually pass the document 140 through the scanner 200. The choice of technique will be strongly influenced by the size and stiffness of the document. As will be explained in detail below, no moving parts are required for this scanner—there is no requirement for a mechanical assembly (typically comprising rollers and drive motors) to control the uniformity of the rate of passage of the document through the scanner and the uniformity of the path that it follows through the slot. The rate of passage does not need to be uniform. The document's passage through the slot can be stopped and then started again, even reversed and then moved forward again, without affecting the electronic image.

The slot scanner can scan documents as quickly as the documents can be manually passed through the slot. A target scan rate is 400 mm per second. The scanner can accommodate appreciably any length of document and any width of document, up to the width of the slot. A slot scanner, as in FIGS. 1 through 5, suitable for A4 size documents might measure 3 cm by 3 cm by 23 cm, or somewhat larger or smaller, depending on manufacturing and ergonomic considerations. The width of the scanner is roughly the width of the slot, which is determined by the maximum width of a document to be scanned. The depth and height of the scanner need only be sufficient to allow scanning hardware to be positioned within the housing, along the surface of the slot.

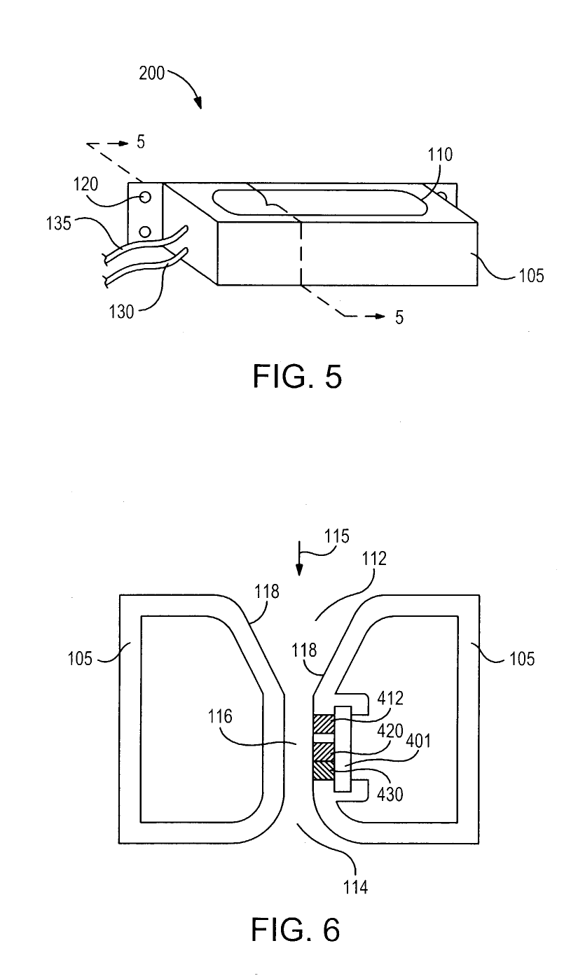

Referring to FIGS. 5, 6 and 7, a wall-mounted slot scanner 200 is shown in detail. The slot scanner includes a housing 105 with a slot 110, shown extending from a top to a bottom surface of the housing. The slot has top and bottom openings 112 and 114, respectively, which are connected by a passage 116 through which documents are manually passed in the direction indicated by arrow 115. The slot defines an interior surface 118 of the housing. This interior surface is the surface of the slot 110. The interior surface may have low friction properties, so as to facilitate the passage of documents. For example, the internal surface may be coated with TEFLON (a federally registered trademark owned by E.I. du Pont de Nemours and Company) or a similar material, for this purpose. The interior surface is configured such that the slot narrows in a uniform manner with distance, from the first opening 112 to the passage 116. This facilitates the insertion of a document into the slot. The wall-mounted slot scanner is attached to a vertical surface by attachment hardware 120 (for example: bolts, screws, etc.). Cable 130 provides power to the scanner, and cable 135 is a serial, USB, SCSI or parallel data connection, typically to a computer. In some embodiments, the power and communications cables may be combined in one.

The optical scanning hardware 400 includes a substrate (for example, a PC board) 401 to which first and second navigational sensors 410 and 412, an illuminator 420, and an image sensor 430 are attached. The sensors may include optical elements, so as to provide a depth of focus which will accommodate the depth of the passage 116. The depth can typically be 6 mm or less. When the design of the slot ensures that documents come into very close proximity (within 1 mm) of the sensors, then the sensors can be contact sensors (with no need of optical elements). As shown in FIG. 6, the sensors and illuminator are located on the interior surface 118, so as to face a document as it is moved through the passage 116. The side of the document facing the sensors will be scanned as the document is moved through the slot.

The image sensor 430 is a linear array of discrete optoelectronic elements extending over substantially the width of the slot, but a two-dimensional array of elements is also a possibility. The spacing of the elements plays a role in determining the spatial resolution of the image that is acquired. For example, a linear array having a length of 101.6 mm requires 1200 sensor elements to achieve a resolution of 300 dpi (dots per inch). Image sensors are currently available with resolutions in the range of 200 to 600 pixels per inch. The image sensor may be a charged coupled device, an amorphous silicon photo-diode array, or other type of sensor array known in the art. Where physical compactness is an issue, the image sensor is preferably a contact image sensor. However, in applications in which compactness is less of a concern, sensors that include conventional (projective) optics may be employed.

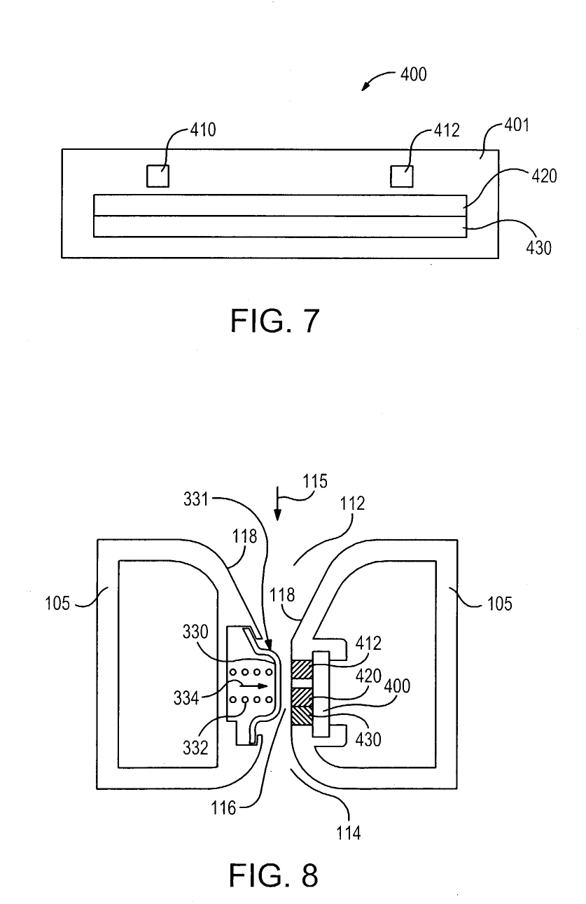

The navigational sensors 410 and 412 are two dimensional arrays of discrete optoelectronic elements located in known positions relative to the image sensor 430. In FIG. 7 the navigational sensors are shown to be spaced apart and positioned symmetrically about the centerline of the image sensor, and consequently about the centerline of the slot. The image sensor forms a signal (e.g., frames of information) that is representative of the image of interest, such as print on the document being scanned. Simultaneously, each navigational sensor forms a signal representative of inherent structure-related properties of the original. “Inherent structure-related properties” are defined herein as properties of the document that are attributable to factors that are independent of forming image data and/or systematic registration data on the document. For most paper documents, paper fibers may be imaged by the navigational sensors. For glossy documents, specular patterns may be imaged. Navigation information is generated when inherent structure-related data is scanned and processed. Image data captured by the image sensor 430 may be “position-tagged” on the basis of the navigation information from the navigational sensors 410 and 412. Note that navigation information may also be generated by detecting print on the document, independent of the acquisition of image data.

The slot scanner 200 can provide monochrome scanning. Emitted light from the illuminator 420 may be in the visible range, but this is not essential. Color scanning is possible with either a single set of sensors and multiple wavelengths of sequential illumination or multiple sets of sensors (with different wavelength sensitivies) and a single broadband illuminator. There may be a single illuminator for all sensors, as shown in FIG. 7, or each sensor could have its own proximate illuminator.

FIG. 8 shows a cross-section through the scanner of FIG. 5, in which an addition has been made to bring the document into contact with the optical sensors. A pressure plate 330 is urged to move in the direction indicated by arrow 334 by a spring 332, so as to push a document against the navigational and image sensors. The spring is sufficiently weak to allow ease of insertion of the document into the slot. The document enters the slot at the opening 112, as indicated by the arrow 115. Consequently, the surface of the pressure plate is well rounded in the region indicated by 331, so as not to impede the movement of the document through the slot. Other suitable designs for a pressure plate, known to those skilled in the art, may be used. When a pressure plate is used, the navigational and image sensors can be contact sensors.

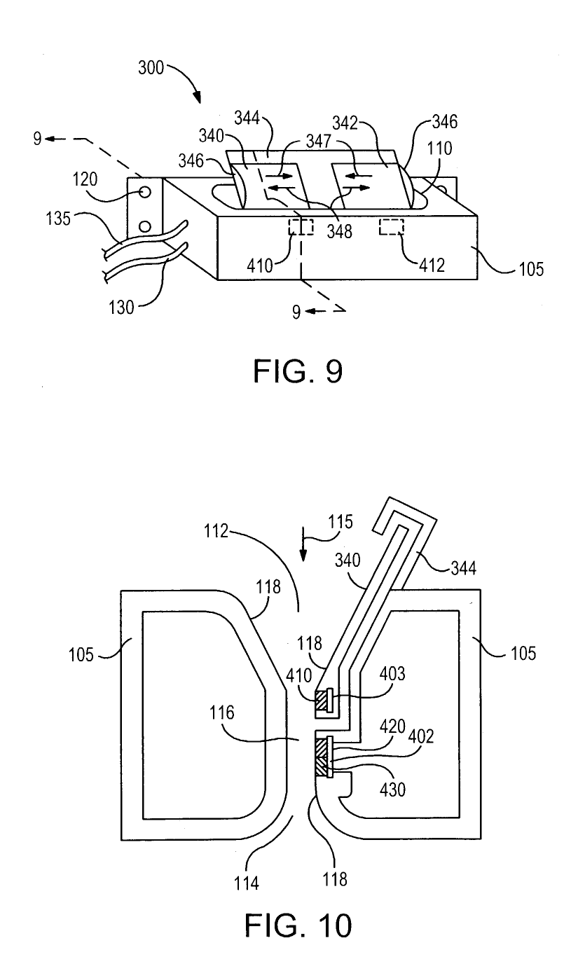

With reference to FIGS. 9 and 10, a slot scanner 300 is shown with an integrated document guide. This scanner differs from the scanner 200, shown in FIGS. 5, 6 and 7, in the following ways: firstly, a document guide, as is well known to those skilled in the art and commonly used on printers and copiers, is added; secondly, the navigational sensors 410 and 412 (shown by dashed lines in FIG. 9) are now located on the movable members of the document guide.

The document guide includes first and second movable members 340 and 342, a support structure 344 and end pieces 346. The movable members are configured to move together, both toward or away from each other, as indicated by arrows 347 and 348, respectively. These movable members move transversely to the document in the slot scanner 300 and symmetrically about the centerline of the slot. The movable members are shown at their full outward positions in FIG. 9, but can be moved inwardly to accommodate documents of less width. The support structure 344, in combination with the housing 105, provides a rigid structure within which the movable members can slide. The end pieces 346 are used to constrain the edges of a document being manually fed through the slot. The optical scanning hardware in the slot scanner 300 includes an illuminator 420 and image sensor 430 mounted on a substrate 402, and navigational sensors 410 and 412 mounted on separate substrates. In this embodiment there is one navigational sensor mounted on each movable member 340 and 342, but only substrate 403 can be seen in FIG. 10. Positioning one or more of the navigational sensors on the movable members ensures that the sensors will “see” the document as it passes through the scanner, irrespective of the width of the document. Since the moveable members extend into the passage 116, they need to be flush with the interior surface 118, and can be considered to be part of this interior surface. It will be clear to those skilled in the art that other designs of document guide may also be configured to work with the scanner of this invention.

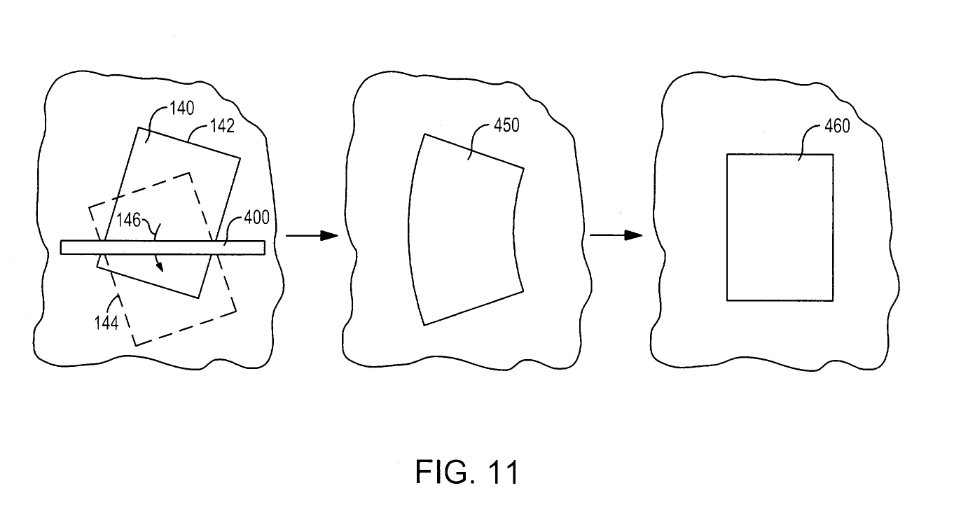

Referring now to FIG. 11, a conceptual representation is shown of the image capture operation of a slot scanner. A document 140 is being moved past the optical scanning hardware 400. The document is moved from a first position 142 to a second position 144, following an arcuate path, as indicated by the arrow 146. Note that the path is exaggerated for ease of illustration. The document is subject only to minimal kinematic restraints in the plane of the document itself. Consequently, the user might move the document through the scanner in such a way that there is a significant change in skew of the document during image capture—one side of the document will move past the image sensor more rapidly than the other side. A distorted electronic image 450 of the document is captured as the document is moved from position 142 to 144. The captured image 450 would be the stored image in the absence of processing to be described below. However, as the image sensor captures data related to the document 140, navigation information is acquired. One or more navigational sensors capture data related to inherent structural features of the document. Movement of the inherent structural features relative to the scanning hardware 400 is tracked in order to determine displacement of the document relative to the hardware. An image 460, faithful to the original document (image distortion artifacts removed), may then be formed. The image 460 is defined herein as the “rectified” image.

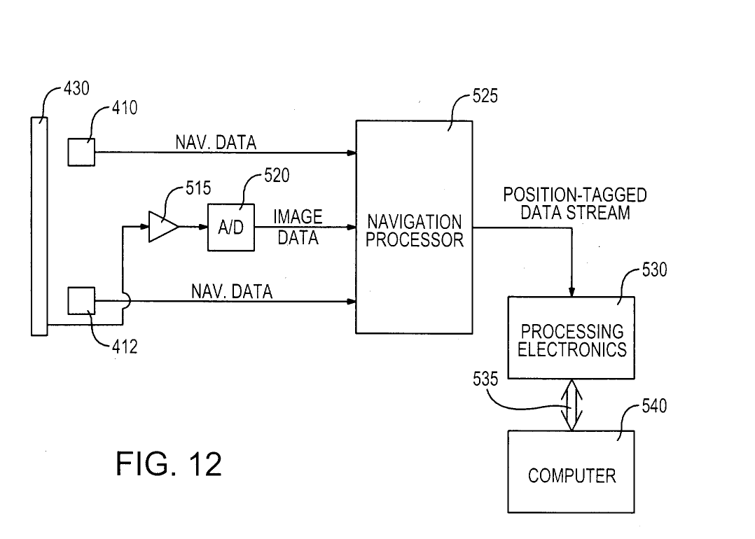

Referring to FIG. 12, the block diagram shows: navigational sensors 410 and 412 which supply navigation data to the navigation processor 525; image sensor 430 which supplies image data to navigation processor 525, the image data having been amplified by amplifier 515 and converted by analog-to-digital converter 520; the navigation processor supplies a “position-tagged” data stream to processing electronics 530, which generates a rectified image. Moreover, there is a communications link 535 between the processing electronics and a computer 540. The communications link can be serial, USB, SCSI, parallel or even wireless. The combination of navigation processor and processing electronics will be referred to herein as an image processor. The image processor combines the operations necessary to produce a faithful electronic reproduction—rectified image—of the document being scanned. Although FIG. 12 shows only a single tap from the image sensor 430 and a single analog-to-digital converter 520 connected to an amplifier 515, there may be multiple taps with dedicated converters and amplifiers. As one possibility, the navigation processor 525 may be the ASIC which was developed for the Hewlett-Packard handheld scanner referred to as the CapShare 920; however, other processors and alternative approaches may be substituted.

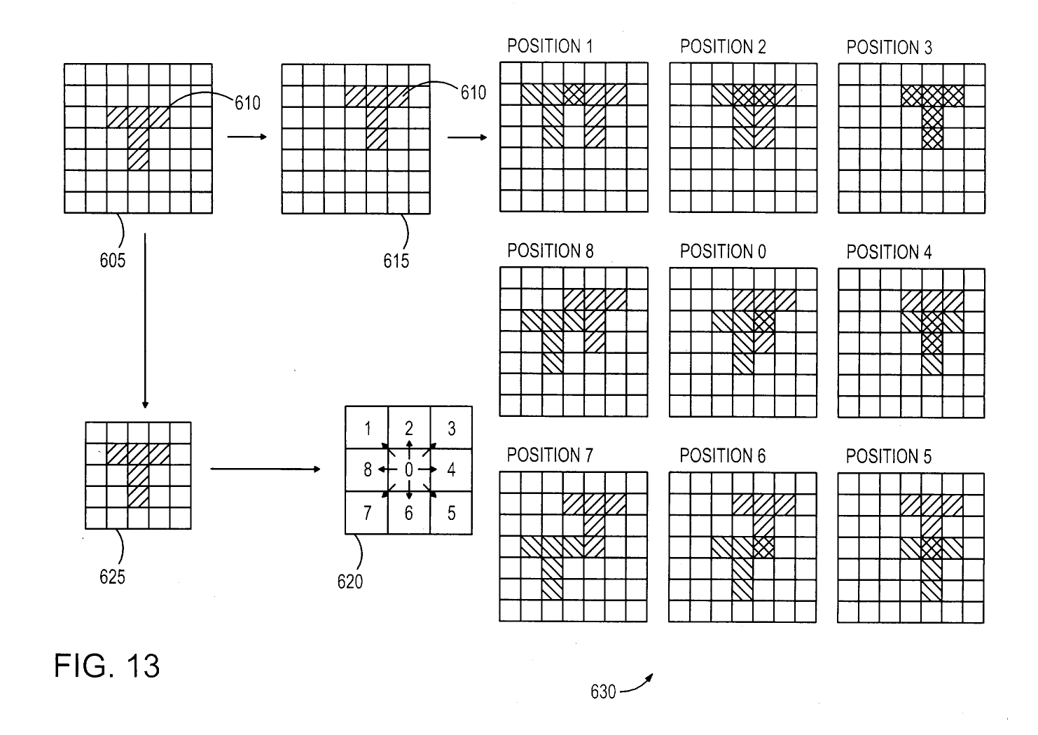

Navigation data, from the navigational sensors 410 and 412, is received by the navigation processor 525. The processor performs a correlation procedure to determine coordinates for the current position of each navigational sensor. The navigation processor 525 simultaneously receives image data from the image sensor 430. Corresponding position coordinates of the navigational sensors are used to “tag” the ends of each line of image data, where a line is one output from each of the pixels within the image sensor 430. The correlation procedure is described in greater detail in U.S. Pat. No. 6,195,475 to Beausoleil, Jr. et al., which is assigned to the assignee of the present invention. While other correlation processes may be substituted, the approach will be described conceptually with reference to FIG. 13.

In FIG. 13, a reference frame 605 is shown as having a structural feature 610 that has a T-shape. The reference frame is a single frame of information from one of the navigational sensors 410 or 412 of FIG. 12. The size of the reference frame depends upon factors such as: the maximum relative movement, in the time between acquisitions of successive frames, of the document being scanned and the scanner; the spatial frequencies in the imaging of the structural or printed features of the document; and the image resolution of the navigational sensor. A practical size of the reference frame 605, for a navigational sensor that is 32 pixels by 64 pixels, is 24×56 pixels. At a subsequent time (t+dt), the navigational sensor acquires the next sample frame 615 which is displaced with respect to the reference frame 605, but which includes the same T-shaped structural feature 610. The duration, dt, should be selected such that, at the relative velocity of the document and the scanner, the relative displacement of the T-shaped feature 610 is equal to or less than the pixel spacing in the navigational array. An acceptable dt, for velocities as high as 0.45 meters/seconds at resolutions of 12 line-pairs per millimeter, is 50 microseconds.

If the document has moved during the time period dt, between the capture of the reference frame 605 and the capture of the sample frame 615, then the first and second images of the T-shaped feature 610 will be ones in which the feature has shifted. Note that while dt should allow time for less than a full-pixel movement, the schematic representation of FIG. 13 shows the feature 610 as being shifted upward and to the right by one pixel; this full-pixel shift is shown only to simplify the representation.

The displacement representation element 620 of FIG. 13 shows a sequential shifting of the pixel values of a subframe 625 from the reference frame 605. The sequential shifting represented by element 620 provides an array 630 in which the pixel values of the subframe 625 are shown in eight different nearest-neighbor pixel positions. A ninth position is represented by no shift. That is, “Position 0” does not include a shift, “Position 1” is a diagonal shift upward and to the left, “Position 2” is an upward shift, etc. In this manner, the nine pixel-shifted templates of 620 can be sequentially combined with the sample frame 615 to produce the array 630 of template-to-sample comparisons. The position frame designated as “Position 0” does not include a shift, so that the result is merely a combination of sample frame 615 and subframe 625. “Position 3” has the minimum number of shaded pixels, and therefore is the frame with the highest correlation. Stated differently, “Position 3” is the template-to-sample comparison with the greatest overlap of the two representations of the T-shaped feature 610. Based upon the correlation results, the position of the T-shaped feature in the sample frame 615 is determined to be a diagonal rightward and upward shift relative to the position of the same feature in the earlier-acquired reference frame 605. Therefore, it follows that the document moved leftward and downward during the time dt.

Using the correlation approach described with reference to FIG. 13, it is necessary to periodically replace the reference frame 605. Optionally, the reference frame can be replaced by the next-acquired sample frame 615 following each sample time dt. Alternatively, the system may monitor each occurrence of an image feature, such as the T-shaped feature 610, moving more than one pixel length, with the reference frame being replaced upon each such occurrence.

Based upon the correlation processing, image data from the image sensor can be position-tagged to include X and Y coordinates. As is shown in FIG. 12, this allows a position-tagged data stream to be generated at the output of the navigation processor 525. The next operation is to map the position-tagged increments of the data stream. The mapping is carried out by the processing electronics 530. This may be accomplished using techniques known in the art. One approach for determining the physical locations of each pixel of image information is a modification of the Bresenham Raster Line Technique. The modification to the technique is that, because the navigational and image sensors are fixed, the line loop will be fixed at the same number. When all of the image data is mapped, it is assembled into a rectified image (image distortion artifacts removed), which is available at the output of the processing electronics.

The image sensor 430 in FIG. 12 is clocked as the document moves through the slot of the scanner. The clocking ensures that the fastest moving part of the document, relative to the scanner, is sampled at least once per pixel displacement by the image sensor. As previously noted with reference to FIG. 11, in the case of significant change in skew of the document during image capture, one side of the document will move past the image sensor more rapidly than the other side, causing pixels at the slower side to be over sampled. This situation can be handled by either recording the most recent reading (for grayscales) or by recording in a logical OR mode (for binary images) at a specific location in image space.

When a document is scanned with an initial skew, it is desirable to be able to compensate for this skew, providing a rectified image in which the document is “straightened.” This function was incorporated in HP 4s and CapShare 920 scanners, and can be incorporated into the image processor of the slot scanner.

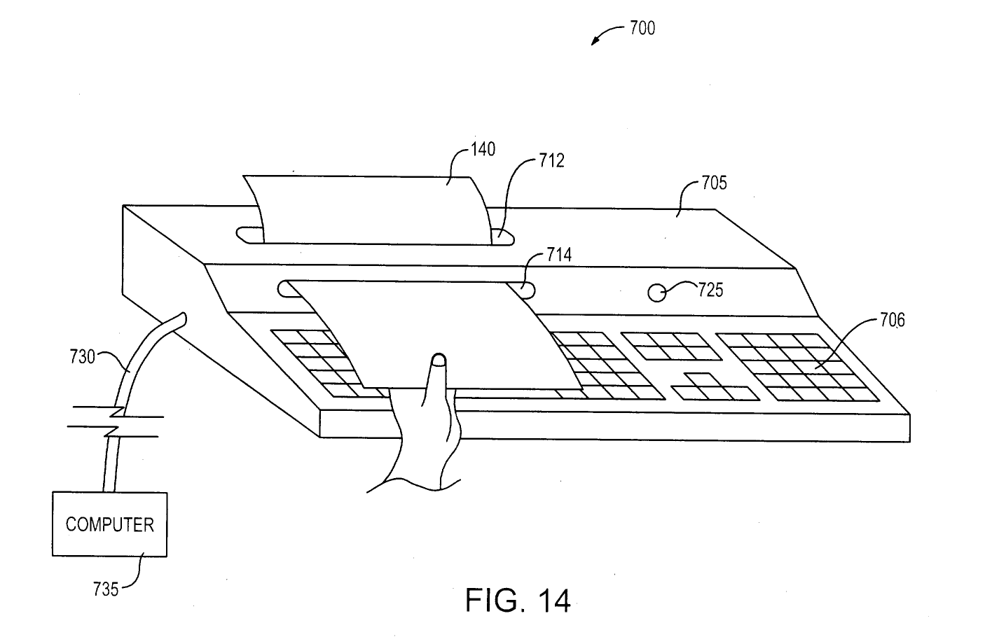

The compact configuration of the slot scanner facilitates its integration into computers and peripheral devices. For example, FIG. 14 shows a perspective view of a slot scanner integrated into a computer keyboard housing 705 (keys 706, and associated electronics, are coupled to the housing). A document 140 is shown being manually pulled through the integrated slot scanner. The slot scanner has first and second openings 712 and 714, on top and front facing surfaces, respectively. Alternative locations for the slot openings could be back and front facing surfaces, and back and top facing surfaces. An electronic image of the document is generated by using optical scanning hardware located within the slot. A light 725 (an LED or the like) can be used to indicate the status of the scanner—yellow indicating ‘ready,’ green indicating ‘scanning OK’ and red indicating ‘error.’ The integrated keyboard and slot scanner are linked by cable 730 to a computer 735. The cable provides power and a communication link for both the keyboard and the scanner. An image processor for the slot scanner, as described with reference to FIG. 12, can be incorporated within the keyboard housing, or can be incorporated within the computer 735. Further, the components of the image processor can be divided between the keyboard housing and the computer—the navigation processor can be located in the keyboard housing and the processing electronics in the computer.

The slot scanner can also be integrated into all-in-one printer-copier-scanner-fax devices. The low power consumption and compactness of the slot scanner makes it well suited for integration into portable devices such as laptop computers.

Some embodiments of the slot scanner may have components made with anti-static surfaces, so as to prevent the build-up of paper dust. It is particularly important to keep the interior surfaces of the housing—for example, surface 118 in FIG. 6—dust free in order to keep the surfaces of the image and navigational sensors unobstructed. Anti-static surfaces will also facilitate the movement of documents through the slot scanner.

Referring to FIGS. 6, 8 and 10, the interior surfaces of the slots are configured such that the slot narrows in a uniform manner with depth, from the first opening 112 to the passage 116; different configurations for the narrowing of the slot are shown—FIG. 6 has a hyperbolic shape, FIGS. 8 and 10 are linear.

Referring to FIGS. 6 and 8, a direction 115 for inserting a document is shown. The indicated direction is the preferred approach for those specific embodiments because of the shape of the slot, which is more gradually narrowed at one end than the other. Other embodiments may have slots which have similar narrowing at both ends, and consequently will allow documents to be inserted from either end (providing the scanning hardware will also accommodate documents passing in either direction).

What is claimed is:

1. A slot scanner for forming a scanned electronic image of a document, said slot scanner comprising:
a housing with a slot configured for manually feeding said document through said slot, said slot being an internal passageway free of mechanical constraints which would block said manual feeding of said document through said internal passageway from a first opening to a second opening;
an image sensor positioned to generate image data of said document as said document is manually fed through said internal passageway;
a first navigational sensor positioned to generate navigation data indicative of current positions of said document as said document is manually fed through said internal passageway; and
an image processor enabled to generate said electronic image based on said image data from said image sensor and said navigation data from said navigational sensor.

2. The slot scanner of claim 1 further comprising a pressure plate positioned along said internal passageway facing said image and navigational sensors, said pressure plate being configured to bias said document against said image and navigational sensors.

3. The slot scanner of claim 1 wherein said navigational sensor includes optoelectronic elements having a resolution sufficient to detect inherent structural features of said document.

4. The slot scanner of claim 1 further comprising a second navigational sensor positioned to generate navigation data indicative of current positions of said document as said document is manually fed through said internal passageway, said second navigational sensor being spaced apart from said first navigational sensor.

5. The slot scanner of claim 1 further comprising an illuminator positioned proximate to said image and navigational sensors along said internal passageway.

6. The slot scanner of claim 1 further comprising a movable document guide aligned with said slot and being adjustable to accommodate documents of a plurality of different widths.

7. The slot scanner of claim 6 wherein said first navigational sensor is positioned on said movable document guide and said movable document guide forms a portion of a surface of said slot.

8. The slot scanner of claim 4 further comprising:
a movable document guide at least partially positioned in said slot and being adjustable to accommodate documents of a plurality of different widths, said guide being formed of first and second movable members, said members forming a portion of a surface of said slot;
wherein said first and second navigational sensors are positioned on said first and second movable members, respectively.

9. The slot scanner of claim 1 further comprising communication means for interfacing with a computer, said slot scanner having an absence of an automated document feed mechanism.

10. The slot scanner of claim 1 wherein said slot has a surface having anti-static properties.

11. The slot scanner of claim 1 wherein said slot has a surface having low friction properties.

12. The slot scanner of claim 1 wherein said slot narrows in a uniform manner with distance from said first opening to said image and navigational sensors, for facilitating insertion of said document into said slot.

13. A method of scanning a document comprising:
manually feeding said document through a slot in a housing without using mechanical document advancement mechanisms;
capturing a sequence of image data as said document moves through said slot;
generating navigation information representative of movement of said document through said slot; and
forming an electronic image from said image data, including removing image distortion artifacts arising from said movement of said document through said slot, said removing image distortion artifacts being based upon said navigation information.

14. The method of claim 13 wherein said generating navigation information includes collecting a sequence of data indicative of variations in skew of said document.

15. The method of claim 13 wherein said generating navigation information includes collecting a sequence of data indicative of variations in speed of said document.

16. The method of claim 13 wherein said forming an electronic image includes processing said generating navigation information to detect variations of inherent structure-related properties of said document.

17. The method of claim 13 wherein said generating navigation information includes detecting print on said document, said generating navigation information being substantially independent of said step of capturing a sequence of image data.

18. The method of claim 13 wherein said manually feeding said document includes pushing said document into said slot.

19. The method of claim 13 wherein said manually feeding said document includes pulling said document out of said slot.

20. The method of claim 13 wherein said manually feeding said document includes dropping said document into said slot.

21. The method of claim 13 wherein said capturing a sequence of image data and said generating navigation information both include illuminating said document.

22. The method of claim 13 further comprising pushing said document against surfaces of image and navigational sensors, said image sensors being utilized in said capturing a sequence of image data and said navigational sensors being utilized in said generating navigation information.

23. An integrated slot scanner and keyboard comprising:
a keyboard housing with a slot configured for manually feeding a document through said slot, said slot extending completely through said housing and having first and second openings, said slot defining an interior surface of said housing;
keys and associated electronics coupled to said housing;
an image sensor positioned on said interior surface, said image sensor having an array of optoelectronic elements;
first and second navigational sensors positioned on said interior surface, said navigational sensors being spaced apart, said navigational sensors having arrays of optoelectronic elements; and
communication means for interfacing with a computer.

24. The integrated slot scanner and keyboard of claim 23 further comprising an image processor enabled to track movement of said document and to generate an electronic image based on data from said image and navigational sensors.

25. The integrated slot scanner and keyboard of claim 23 further comprising an illuminator positioned on said interior surface proximate to said image and navigational sensors.
